(19) United States
(12) Patent Application Publication
(10) Pub. No.: US 2016/0112849 A1
(43) Pub. Date: Apr. 21, 2016

(54) DEVICE AND METHOD FOR TRANSFERRING CALL

(71) Applicants: AMBIT MICROSYSTEMS (SHANGHAI) LTD., Shanghai (CN); HON HAI PRECISION INDUSTRY CO., LTD., New Taipei (TW)

(72) Inventor: AI-NING SONG, Shanghai (CN)

(21) Appl. No.: 14/790,544

(22) Filed: Jul. 2, 2015

(30) Foreign Application Priority Data
Oct. 15, 2014 (CN) 201410545326.2

(51) Int. Cl. H04W 4/16; H04M 3/54; H04W 4/00

(52) U.S. Cl. CPC H04W 4/16; H04W 4/008; H04M 3/543

(57) ABSTRACT

A method for transferring an incoming call from a first communication device to a second communication device inquires as to a preselected process mode. The process mode can include a call answering mode, a call rejection mode, and a call transferring mode. Under the call transferring mode, the first communication device acquires contact numbers of the second communication device through a short distance communication unit. Then the first communication device sends the acquired contact numbers or a transfer command included the acquired information to a server and the server transfers the incoming call from the first communication device to the second communication device.

### CROSS-REFERENCE TO RELATED APPLICATIONS

This application claims priority to Chinese Patent Application No. 201410545326.2 filed on Oct. 15, 2014, the contents of which are incorporated by reference herein.

### FIELD

The subject matter herein generally relates to communications technology.

### BACKGROUND

When a user cannot pick up a phone call, a call transferring is usually used. However, before using the call transferring function, users have to preset a transferring numbers or have to set a transferring command in a complicated menu. Users have to know the transferring numbers before calls are incoming.

### BRIEF DESCRIPTION OF THE DRAWINGS

Implementations of the present technology will now be described, by way of example only, with reference to the attached figures, wherein:

FIG. 1 illustrates a block diagram of elements for an embodiment for transferring a call.

FIG. 2 illustrates a block diagram of a first embodiment of a communication device and a second communication device included in the elements of FIG. 1.

FIG. 3 illustrates a block diagram of a second embodiment of a communication device and a second communication device included in the elements of FIG. 1.

FIG. 4 illustrates a flowchart of an embodiment of a method for transferring a call.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

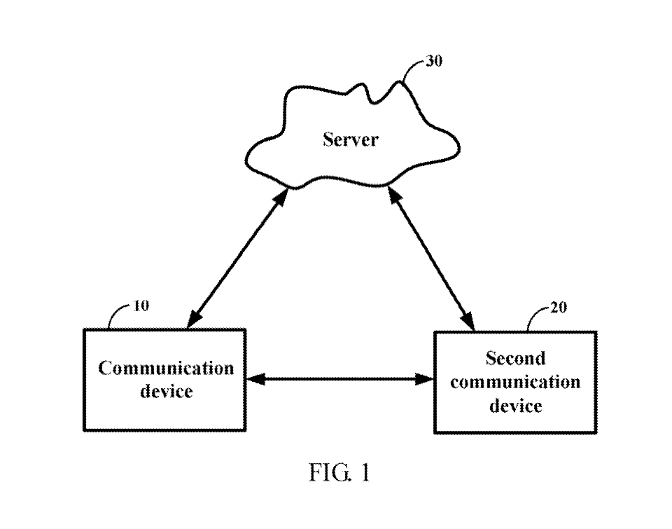

FIG. 1 illustrates a block diagram of elements for an embodiment for transferring a call. In the embodiment, when a communication device 10 needs to transfer a call, the communication device 10 communicates with a second communication device 20 to acquire information including transferring numbers. Then the communication device 10 sends the acquired information to a server 30. Thus the server 30 can transfer the call to the second communication device 20. The communication device 10 and the second communication device 20 can be mobile phones, telephones, or other communication devices. In at least one embodiment, the communication device 10 is a mobile phone. The second communication device 20 is a telephone.

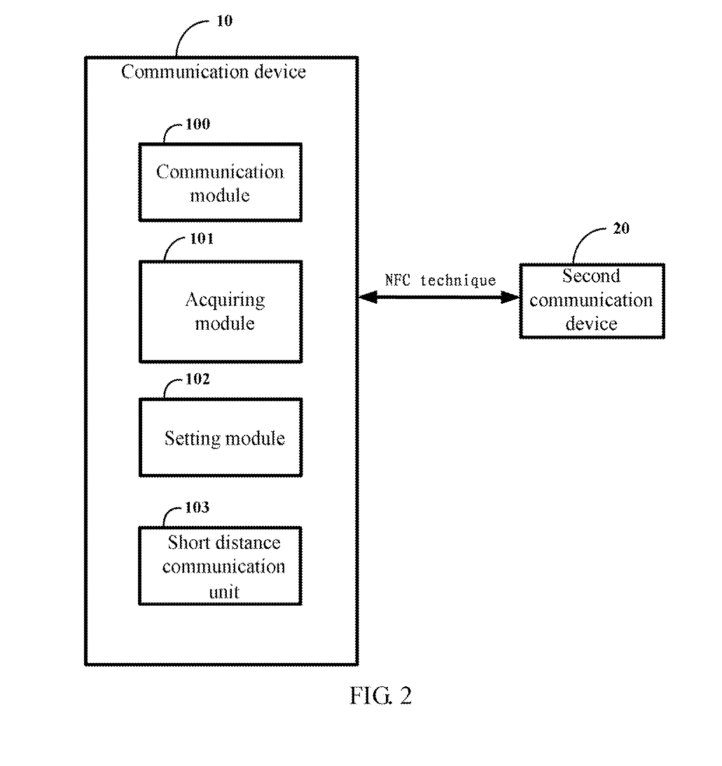

FIG. 2 illustrates a first embodiment of a communication device 10 and a second communication device 20 for transferring a call. The communication device 10 communicates with the second communication device 20 using a Near Field Communication (NFC) technology or Radio Frequency Identification (RFID) technology.

In at least one embodiment, the communication module 100 is configured to receive an incoming call and inquire a process mode input by a user. The process mode includes a call answering mode, a call rejection mode, and a call transferring mode. The communication device 10 includes a communication module 100, an acquiring module 101, a setting module 102, and a short distance communication unit 103.

The acquiring module 101 is configured to acquire information of the second communication device 20 through the short distance communication unit 103. In at least one embodiment, the acquiring information includes transferring numbers or contact numbers of the second communication device 20.

The setting module 102 is configured to send the acquired information to the server 30 according to the selected process mode. Thus the server 30 can transfer the incoming call to the second communication device 20.

In at least one embodiment, the short distance communication unit 103 is able to communicate with other devices through a Near Field Communication (NFC) technology. In other embodiments, the short distance communication unit 103 is able to communicate with other devices through other communication technologies, such as a Radio Frequency Identification (RFID) technology.

When the communication device 10 receives an incoming call, the communication device 10 acquires the contact numbers of the second communication device 20 through the acquiring module 101. Then the communication device 10 sends the acquired contact numbers, or a command including the acquired contact numbers, to the server 30. When the server 30 receives the acquired contact numbers or the command, the server 30 transfers the incoming call to the second communication device 20. The second communication device 20 can thus pick up the incoming call. In at least one embodiment, the contact numbers can be the number of a Subscriber Identity Module (SIM) card or the number of a landline telephone.

In at least one embodiment, the contact numbers of the communication device 20 are stored in an NFC tap. Thus the acquiring module 101 can easily acquire the contact numbers through the short distance communication unit 103. In other embodiments, the contact numbers can be stored in other NFC devices or in other RFID devices.

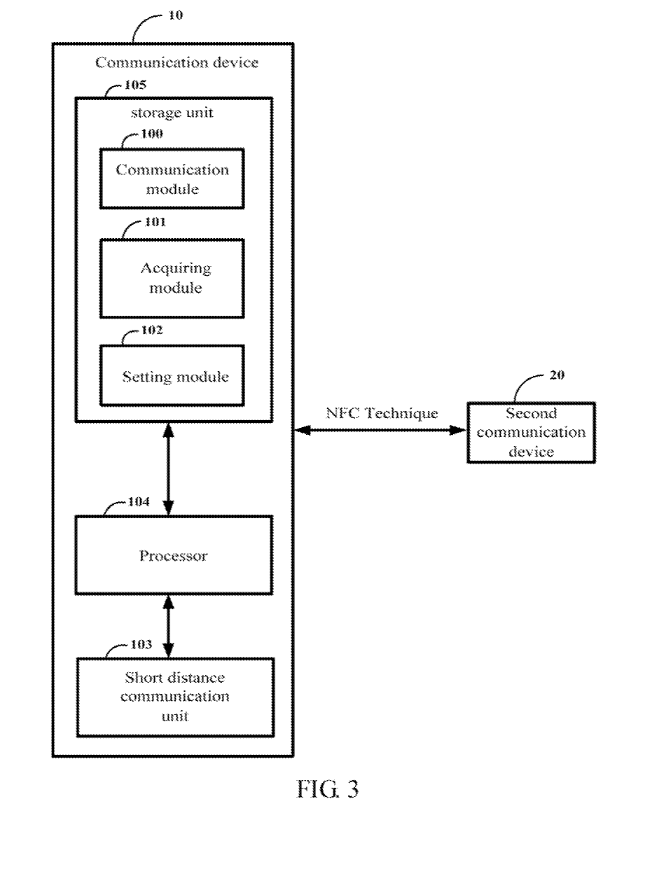

FIG. 3 illustrates a block diagram of a second embodiment of a communication device 10 and a second communication device 20 for transferring a call. In the second embodiment, the communication device 10 includes the communication module 100, the acquiring module 101, the setting module 102, and the short distance communication unit 103 mentioned in the first embodiment. The difference between the first embodiment and the second embodiment is that the communication device 10 in the second embodiment further includes a processor 104 and storage unit 105. The function modules (the communication module 100, the acquiring module 101, and the setting module 102) can include computerized code in the form of one or more programs that are stored in the storage unit 105, and executed by the processor 104 to provide functions of the function modules. The storage unit 105 can be a dedicated memory, such as an EPROM, or a flash memory.

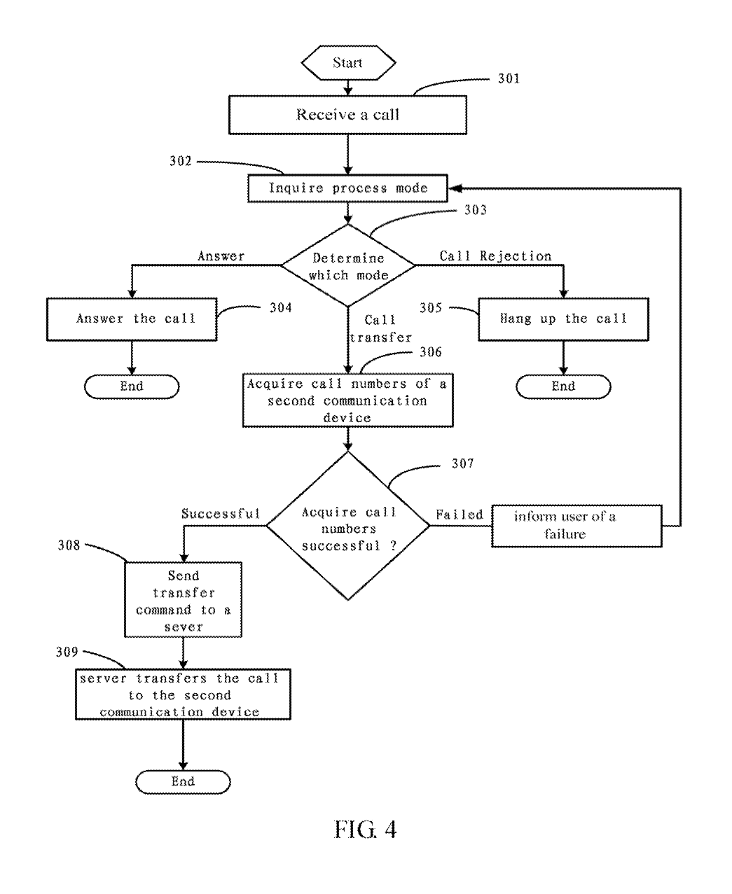

FIG. 4 illustrates a flowchart of an embodiment of a method for transferring a call.

Referring to FIG. 4, a flowchart is presented in accordance with an example embodiment of a method for transferring a call. The method is provided by way of example, as there are a variety of ways to carry out the method. The method described below can be carried out using the configurations illustrated in FIGS. 1-3, for example, and various elements of these figures are referenced in explaining the method. Each block shown in FIG. 4 represents one or more processes, methods, or subroutines, carried out in the exemplary method. Additionally, the illustrated order of blocks is by example only and the order of the blocks can change. The method can begin at block 301.

At block 301, the communication module 100 warns a user about an incoming call by screen display or ringing or vibration. Thus, the user will be aware of the call.

At block 302, the communication module 100 inquires a process mode preselected by the user. The process mode can include a call answering mode, a call rejection mode, and a call transferring mode. When the user has selected a particular process mode, the setting module 102 in the communication device 10 continues to process block 303.

At block 303, the setting module 102 determines which process mode the user has selected. If the user has selected the call answering mode, the communication module 100 continues to apply block 304. If the user has selected the call rejection mode, the communication module 100 continues to apply block 305. If the user has selected the call transferring mode, the communication module 100 continues to apply block 306.

At block 304, the communication module 100 picks up the call and the user answers the call using the communication device 10.

At block 305, the communication module 100 hangs up the call.

At block 306, the acquiring module 101 in the communication device 10 acquires information of the second communication device 20 through the short distance communication unit 103. The acquiring module 101 then continues to block 307 of the process.

At block 307, the acquiring module 101 determines whether the information acquiring is successful. If the information acquiring is successful, the acquiring module 101 sends the information to the setting module 102. The setting module 102 processes block 308. If the information acquiring is failed, the acquiring module 101 informs the user of a failure by screen display or ringing or vibration. The user may then select another process mode.

At block 308 and block 309, the setting module 102 sends a transfer command including the acquired information to the server 30. When the server 30 receives the transfer command, the server 30 transfers the call to the second communication device 20. The user may answer the call using the second communication device 20.

In the embodiments, when users need to transfer an incoming call, the need to know or find the contact numbers of other communication devices does not apply and a transfer of the incoming call becomes automatic.

The embodiments shown and described above are only examples. Many details are often found in the art such as the other features of a device and method for transferring a call. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A first communication device for transferring an incoming call to a second communication device, the first communication device comprising:
at least one processor;
a storage unit; and
one or more programs that are stored in the storage unit and executed by the at least one processor, the one or more programs comprising instructions for:
receiving the incoming call;
inquiring a process mode, wherein the process mode comprises a call answering mode, a call rejection mode and a call transferring mode;
acquiring contact numbers of the second communication device through a short distance communication unit when the call transferring mode is chosen; and
sending a transferring command with the contact numbers to a server, so that the server transfers the incoming call to the second communication device.

2. The first communication device as claimed in claim 1, wherein the short distance communication unit is a unit using a technology of Near Field Communication (NFC) or Radio Frequency Identification (RFID).

3. The first communication device as claimed in claim 1, wherein the one or more programs further comprise instructions for:
picking up the incoming call when the call answering mode is chosen; and
hanging up the incoming call when the call rejection mode is chosen.

4. The first communication device as claimed in claim 1, wherein the one or more programs further comprise instructions for informing a user of a failed contact numbers acquiring by ways of displaying in a screen or ringing or vibration when acquiring contact numbers is failed.

5. The first communication device as claimed in claim 1, wherein the first communication device is a mobile phone, and the second communication device is a telephone.

6. A method for transferring an incoming call from a first communication device to a second communication device, the method comprising:
receiving the incoming call;
inquiring a process mode, wherein the process mode comprises a call answering mode, a call rejection mode and a call transferring mode;
acquiring contact numbers of the second communication device through a short distance communication unit when the call transferring mode is chosen; and
sending a transferring command with the contact numbers to a server, so that the server transfers the incoming call to the second communication device.

7. The method as claimed in claim 6, wherein the short distance communication unit is a unit using a technology of Near Field Communication (NFC) or Radio Frequency Identification (RFID).

8. The method as claimed in claim 6, wherein the method further comprises:
picking up the call when the call answering mode is chosen; and
hanging up the call when the call rejection mode is chosen.

9. The method as claimed in claim 6, wherein the method further comprises:
informing a user of a failed contact numbers acquiring by ways of displaying in a screen or ringing or vibration when acquiring contact numbers is failed.

10. The method as claimed in claim 6, wherein the first communication device is a mobile phone, and the second communication device is a telephone.
